(19) United States
(12) Patent Application Publication
(10) Pub. No.: US 2009/0039047 A1
(43) Pub. Date: Feb. 12, 2009

(54) Method for the manufacture of a baby feeding bottle being provided with a one-way valve

(76) Inventor: Haim Shtalryd, Rishon Le Zion (IL)

Correspondence Address: MYERS BIGEL SIBLEY & SAJOVEC, PO BOX 37428, RALEIGH, NC, 27627, US

(21) Appl. No.: 11/816,352

(22) PCT Filed: Mar. 27, 2006
(86) PCT No.: PCT/IL06/00382

§ 371 Date: Aug. 15, 2007

(30) Foreign Application Priority Data
Mar. 29, 2005 (IL) 167726

(51) Int. Cl. A61J 9/04; B21D 39/00

(52) U.S. Cl. 215/11.5; 29/428

(57) ABSTRACT

The present invention relates to a method for the manufacture of a baby feeding bottle being provided with a one-way valve. The one-way valve carries at its end a tail. The bottle has an opening at the top through which said valve is inserted by any suitable inserting means. Said valve is inserted up to the end through a small round opening having a suitable size corresponding to the groove of the valve being located at the bottom of said bottle. Through the round opening the valve is pulled by any suitable pulling means inside the bottle until the bottom of the bottle is closed hermetically by the valve. Finally the tail of the valve is cut off by any cutting means.

The present invention relates to a method for the manufacture of a baby feeding bottle being provided with a one-way valve.

There are known many bottles for feeding infants. Such bottles are mainly made of a soft material, e.g. an elastomer, rubber or plastic. When using said bottles the infant sucks on the nipple which is located at the top of the bottle. Since the bottle is a closed container, during nursing a vacuum is formed, as a result of this the infant is forced, while eating, to release his mouth from the nipple and to adjust the pressure in order that the food can come out. During the relaxation from the nipple, the infant swallows air, and thus causes, according to a widespread theory, colic pain.

Many attempts were made to solve the problem of the vacuum, by using a tubule, situated inside the bottle and connected to an external conduit on the cap. The tubule balances in a fixed manner the air pressure in the bottle known as “Dr. Brown method” which is described inter alia in U.S. Pat. No. 5,570,796 and U.S. Pat. No. 5,779,071. The main deficiency of this method is the multiplicity of parts required due to which the assembly, disassembly and cleaning of the bottle are complicated.

An additional system of such bottle which is more widespread is to use a nipple which is located at the top of said bottle and provided with a number of valves, which valves penetrate air from the outside inward. The main deficiency in this system is that the penetration of the air occurs when it passes through the baby food, which is blended with it, is swallowed and permeates to the stomach.

There are known many baby feeding bottles, inter alia, being provided with one-way valves, e.g. such described in British Patent Application No. 2422646. However there is not known any suitable method to manufacture such a baby feeding bottle provided with a one-way valve of an easy and cheap mechanism. i.e. with easy insertion of the on-way valve. It was thus an important object to find such a method.

The present invention thus relates to a method for the manufacture of a baby feeding bottle being provided with a one-way valve (hereinafter: “valve”) which valve carries at its end a tail, said bottle having an opening at the top through which said valve is inserted by any suitable inserting means, e.g. any suitable tool such as tweezers etc, which valve is inserted up to the end through a small round opening having a suitable size corresponding to the groove of the valve being located at the bottom of said bottle, through which round opening the valve is pulled by any suitable pulling means, e.g. manual or automatic mechanical tool inside the bottle until the bottom of the bottle is closed hermetically by the valve, finally the tail of the valve being cut off, e.g. by any cutting means e.g. cutting tools such as scissors, a knife etc.

More specifically, the insertion of the valve is suitably performed by means of holding the valve with a suitable tool, e.g. tweezers, from the direction of the top opening of the bottle until it reaches said round opening, which is located at the bottom of the bottle. The valve is then pulled with the aid of said pulling means inside the bottle opening and thus passes the basis of the round opening located at the bottom of the bottle. During the passage it is contracted, due to the force of gravity. The groove, which was arranged in the valve for this purpose, eases its entry, and expands after passing the basis. In the next stage the tail of the valve extending outwards is cut off, with the help of a cutting tool, e.g. scissors or a knife. As a result of said action the bottle is hermetically closed.

The valve is advantageously made from a soft material, e.g. an elastomer, rubber or plastic, in such a manner that it fulfills two functions simultaneously:
a. causes the valve to be one-way; and
b. seals the bottom opening of the bottle with no need for sealing material.

The advantage of said one-way valve is that the air in the bottle comprising same does not blend with the food and the cleaning of said bottle is simple.

In a preferred embodiment of the present invention the valve of the present invention is composed of a common one-way valve having the addition of a tail e.g. the valve having a close trimmed triangle structure ending in two plates in which the upper plate is larger then the lower plate; and between both plates a groove being present; which lower plate being connected to an open cylinder which is being a tail. The inside space of the valve is closed in the triangle structure and open beneath the lower plate in the cutting section.

The patent comprises the planned addition of a valve's “tail”, which enables pulling it inward through the round opening and its location. In contrast to the pulling system as suggested here, due to the soft material, from which the valve is made, there is no other possibility to push it inward, inside the round opening. Such a pushing attempt would cause expansion of the elastomer and impenetrability. The addition of the tail to the valve enables its pulling inward, its location and the cutting off of the excess tail later on.

The present invention will now be illustrated with reference to the accompanying drawings without being limited by them. Identical parts appearing in separate figures are being indicated by the same numerals. In said drawings:

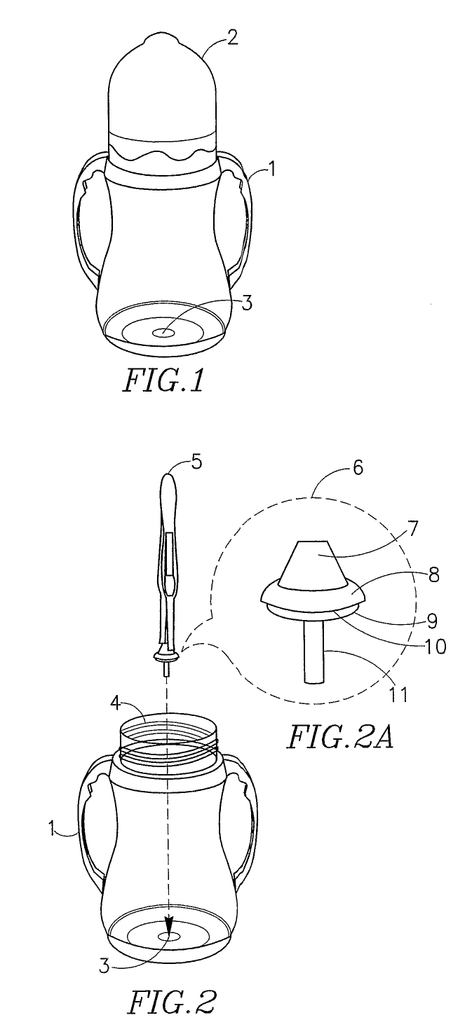

FIG. 1 shows a side view of the closed bottle according to the present invention without the valve;

FIG. 2 shows a side view of the bottle according to the present invention in the insertion stage of the valve;

FIG. 2a shows a detailed view of the valve of FIG. 2 according to the present invention;

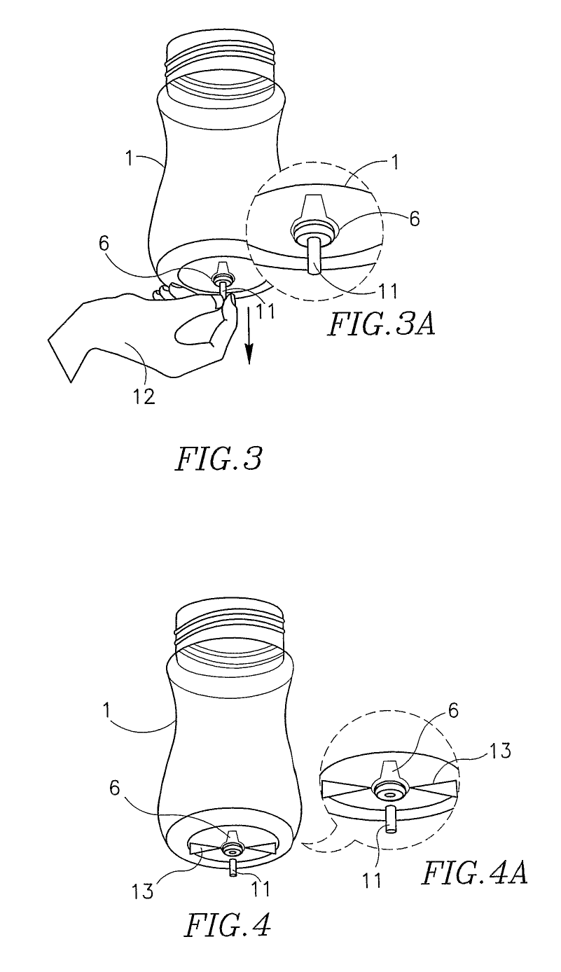

FIG. 3 shows a perspective view of the bottle provided with a valve, according to the present invention, in the pulling stage;

FIG. 3a shows a detailed view of the valve of FIG. 3 being part of the bottle, according to the present invention;

FIG. 4 shows a perspective view of the bottle being provided with a valve, according to the present invention in the cutting position; and

FIG. 4a shows a detailed view of the valve of FIG. 4 according to the present invention.

FIG. 1 shows empty bottle (1) closed with cover (2) having round opening (3) at the bottom of bottle (1).

FIG. 2 shows empty bottle (1) being provided with opening (4) at the top and with round opening (3) at the bottom. Upon opening (4) is shown tweezers (5) holding at its bottom valve (6). Valve (6) is shown in an enlarged structure as FIG. 2a. Valve (6) is composed of a close trimmed triangle structure (7). Said structure (7) is provided with two plates (8) and (9) in which upper plate (8) is larger then lower plate (9). Between both plates (8) and (9) groove (10) is present. Lower plate (9) is connected to an open cylinder being tail (11).

FIG. 3 shows a perspective view of bottle (1) and FIG. 3a shows a bottom view of valve (6) being part of bottle (1), valve (6) being inserted into bottom opening (3) and pulled downwards with the aid of tail (11) by hand (12)

FIGS. 4 and 4a show the final position, i.e. valve (6) is extending through round opening (3) and closes same hermetically. Tail (11) extends outwards and is cut by a cutting tool (13), e.g. scissors, a knife etc, Then the bottle is ready to be used.

1. A method for the manufacture of a baby feeding bottle having a one-way valve, the valve carrying at its end a tail, the bottle having an opening at the top, the method comprising:
inserting the valve up to an end through a small round opening having a suitable size corresponding to a groove of the valve and being located at the bottom of the bottle;
pulling the valve through the round opening inside the bottle until a bottom of the bottle is closed hermetically by the valve;
cutting off the tail of the valve.

2. A method according to claim 1, wherein the valve is a close trimmed triangle structure ending in two plates in which the upper plate is larger than the lower plate; and the groove is between the plates; the lower plate being connected to an open cylinder being the tail, an inside space of the valve being closed in the triangle structure and open beneath the lower plate in the cutting section.

3. A method according to claim 1, wherein the valve is inserted with tweezers.

4. A method according to claim 1, wherein the the tail is cut with one of scissors and a knife.

5. A method according to claim 1, wherein the the valve is pulled by one of manual means and automatic mechanical pulling tools.

6.-7. (canceled)

8. A one-way valve having a tail.

9. A baby feeding bottle comprising:
a one-way valve, the valve carrying at its end a tail, the bottle having an opening at the top through which the valve is inserted up to an end through an opening having a suitable size corresponding to a groove of the valve and being located at the bottom of the bottle, the valve being pulled inside the bottle until a bottom of the bottle is closed hermetically by the valve.
